(19) United States
(12) Patent Application Publication
(10) Pub. No.: US 2019/0035299 A1
(43) Pub. Date: Jan. 31, 2019

(54) SYSTEM AND METHOD FOR TRAINING IN THE DEPLOYMENT AND RECOVERY OF AIRCRAFT FROM A TRAINING SIMULATOR

(71) Applicant: Pacific Tugboat Service, San Diego, CA (US)

(72) Inventor: LARRY A. WILSKE, SAN DIEGO, CA (US)

(73) Assignee: Pacific Tugboat Service, San Diego, CA (US)

(21) Appl. No.: 15/662,033

(22) Filed: Jul. 27, 2017

(51) Int. Cl. G09B 9/44; G09B 9/08; G09B 19/16

(52) U.S. Cl. CPC G09B 9/44; A62C 3/10; G09B 19/165; G09B 9/085

(57) ABSTRACT

Disclosed herein are various methods for implementing a training simulator. The disclosed training simulator may include training systems for the deployment and recovery of aircrafts from simulated aircraft carriers. Such methods may include implementing a training simulator by initially collecting a data specification of an aircraft carrier to be replicated to create a simulated aircraft carrier structure, where the simulated aircraft carrier structure is a flight deck of the aircraft carrier to be replicated. The method may also include obtaining a platform to implement the simulated aircraft carrier structure on top of the platform; lowering the platform onto a body of water; and implementing a training program to be performed on the simulated aircraft carrier structure.

### TECHNICAL FIELD

The disclosed technology relates generally to creating training systems. More specifically, the disclosed technology relates to creating training systems for the simulation of the deployment and recovery of aircrafts onto aircraft carriers.

### BACKGROUND

An aircraft carrier is a large vessel that serves as a seagoing airbase and is equipped with a flight deck for the facilitation of carrying, arming, deploying, and recovering aircrafts. As a result, this allows naval forces the ability to transport aircrafts all over the world.

A noticeable difference with runways on an aircraft from those on land is that runways on the aircraft carrier are significantly shorter in length. Indeed, most flight decks have only about 300 feet of runway space compared to the 2,300 feet available for runways stationed on the land. Additionally, aircrafts carriers are moving and floating on top of a moving body of water, which requires pilots to also consider the swaying and heaving motion of the aircraft carrier. As a result, deploying and recovering aircrafts from aircraft carriers are often considered to be a high peril endeavor that requires great precision, skill, and training.

Because proper and adequate training requires that the pilot and crew members train on aircraft carriers out at sea, aircraft carriers must then be deployed at sea. However, deploying an operational aircraft carrier at sea for each training session is not only costly, but may also result in costly damages to the aircraft carrier.

### BRIEF DESCRIPTION OF THE EMBODIMENTS

Disclosed herein are various methods for implementing a training simulator. The disclosed training simulator may include training systems for practicing the deployment and recovery of aircrafts from simulated aircraft carriers. Such methods may include implementing a training simulator by initially collecting a data specification of an aircraft carrier to be replicated to create a replicated aircraft carrier structure. The replicated aircraft carrier structure may be a flight deck of the aircraft carrier. The method may also include obtaining a platform to implement the simulated aircraft carrier structure on top; lowering the platform onto a body of water; and implementing a training program to be performed on the replicated aircraft carrier structure.

Additionally, also disclosed is a system or a kit for a training simulator, which may include a data specification of an aircraft carrier to be replicated resulting in a replicated aircraft carrier structure. The kit may also include a platform and one or more units that includes a replicated aircraft carrier structure implemented on top of the platform, where the simulated aircraft carrier structure includes at least one of a stern, a bow, a starboard side, a port side, a flight deck, a landing pad, and a control tower.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

Various embodiments are disclosed herein and described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 illustrates sections of the aircraft carrier structure to be replicated according to one embodiment.

FIG. 2 is a flow diagram for creating a training simulator for deploying and recovering aircrafts according to one embodiment.

FIG. 3A illustrates a side view of a simulated aircraft carrier structure according to one embodiment.

FIG. 3B illustrates a top view of a landing pad of the simulated aircraft carrier structure of FIG. 3A.

FIG. 4 illustrates a data specification of a flight deck of a real aircraft carrier to be simulated according to one embodiment.

FIG. 5 illustrates a data specification of a flight deck of a real aircraft carrier to be simulated according to one embodiment.

The figures are not intended to be exhaustive or to limit the invention to the precise form disclosed. It should be understood that the invention can be practiced with modification and alteration, and that the disclosed technology be limited only by the claims and the equivalents thereof.

### DETAILED DESCRIPTION OF THE EMBODIMENTS

The following description is not to be taken in a limiting sense, but is made merely for the purpose of describing the general principles of the disclosed embodiments. The present embodiments address the problems described in the background while also addressing other additional problems as will be seen from the following detailed description. Numerous specific details are set forth to provide a full understanding of various aspects of the subject disclosure. It will be apparent, however, to one ordinarily skilled in the art that various aspects of the subject disclosure may be practiced without some of these specific details. In other instances, well-known structures and techniques have not been shown in detail to avoid unnecessarily obscuring the subject disclosure.

Disclosed herein are various embodiments of a training simulator for teaching and training pilots and crew members in the deployment and recovery of aircrafts from a simulated aircraft carrier. Providing the necessary training associated in the deployment and recovery of aircrafts is vital for pilots, especially considering when the techniques required for the take-off and landing of aircrafts from an aircraft carrier require great skill and precision. Furthermore, crew members are also involved in ensuring that the pilot successfully take-off and land the aircraft, thus requiring that the crew members are also adequately trained. For example, crew members require the necessary skills to properly communicate and convey instruction to the pilot, to prepare and handle the gear needed to deploy and recover the aircrafts, and to prepare for a wide range of emergency situations.

To provide the necessary training environment to both the pilots and crew members, a training system may be implemented to provide a training simulator or training environment to hone the necessary skills required. In some embodiments, the training system may include a replicated structure of a real aircraft carrier to be used as a training simulator. By way of example, the real aircraft carrier may be one that is still in service in the United States Navy. As a result, the training system may provide a highly realistic training environment in preparing pilots and crew members with the necessary skills for naval combat.

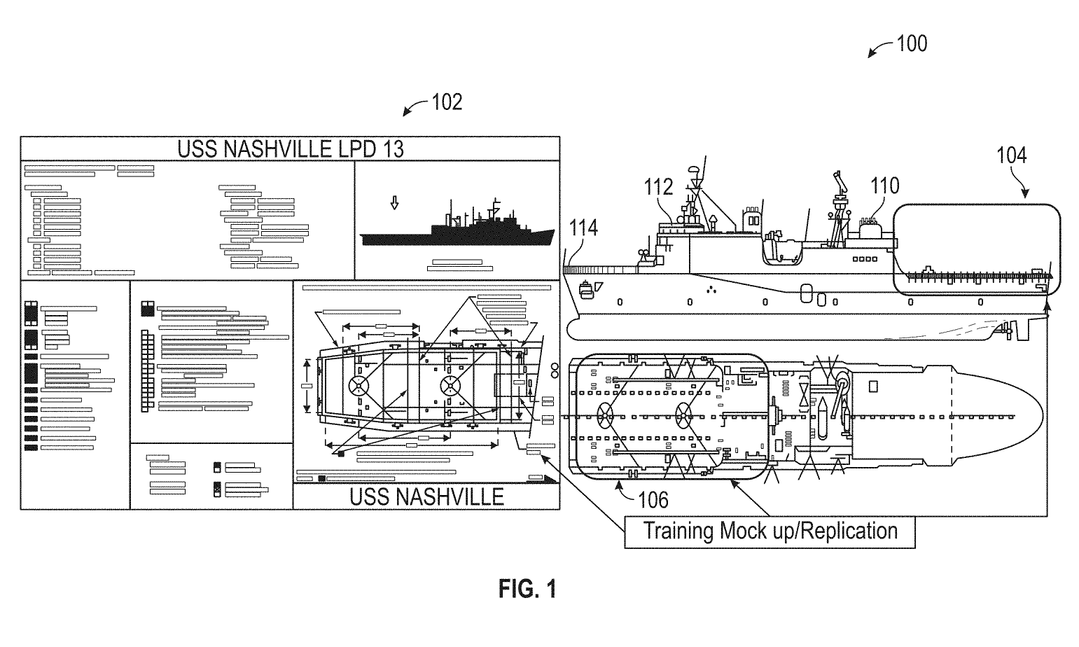

FIG. 1 illustrates sections of the real aircraft carrier 100 to be replicated according to one embodiment. The figure depicts sections of the real aircraft carrier that may be replicated to be used as a training simulator for training purposes. The simulated or replicated aircraft carrier structure may be herein referred to as the simulated aircraft carrier structure. To create the simulated aircraft carrier structure with the exact specifications of the real aircraft carrier, real blueprints or data specification sheets 102 of the real aircraft carrier may be used. Here, by way of example, the USS Nashville aircraft carrier is being replicated and its specification sheet 102 may be used to obtain the necessary dimensions needed to replicate it.

In some embodiments, different sections of the real aircraft carrier may be replicated. For example, many hours of training are required to help prepare pilots and crew members with the skills necessary to land and recover an aircraft. As a result, it may be preferable to replicate only the flight deck 104, 106 sections to allow pilots practice taking off and landing on a simulated aircraft carrier structure. Additionally, the crew members may also utilize the simulated aircraft carrier structure to prepare and train for the necessary skills associated with the deployment and recovery of aircrafts, such as preparing the flight deck 104, 106 with the necessary gear to deploy and recover aircrafts, communicating with the pilot with appropriate landing instructions, preparing for emergency scenarios, and the like.

In further embodiments, other sections of the real aircraft carrier structure 208 may also be replicated, such as the control tower 110, operation room 112, bow 114, or any other section of the real aircraft carrier structure needed for training purposes.

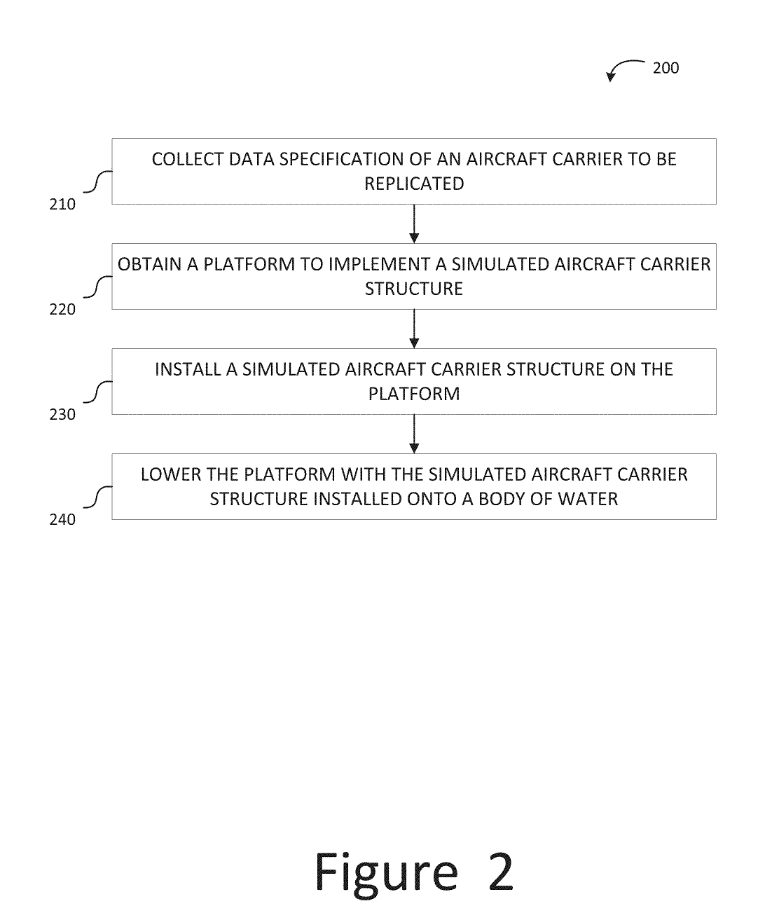

FIG. 2 is a flow diagram 200 for creating a training simulator for deploying and recovering aircrafts according to one embodiment. In order to provide a simulated training environment for the pilots and the crew, an actively deployed aircraft carrier may be replicated to scale.

Thus at step 210, data specifications of the real aircraft carrier of interest may be collected to provide the necessary specifications and physical details needed to replicate the real aircraft carrier. In some embodiments, the complete and physical structure of the flight deck may be replicated. In other instances, only select and distinct sections of the real aircraft carrier may be replicated, such as the landing pad or the control tower. By replicating the entire flight deck or select portions of the deck of the real aircraft carrier, pilots and crew members may be trained in an immersive and realistic environment next best to training on the real aircraft carrier itself.

In some embodiments, the data specifications may be used to implement the level of detail required to simulate or replicate the real aircraft carrier of interest. Indeed, the data specifications may include the height, width, and length of the flight deck of the entire perimeter of the aircraft carrier or the specifications for certain aspects, such as the runway. Other information may include the placement and location of fixtures, structures, equipment, and weaponry so that the location and placement of these structures and items may be replicated.

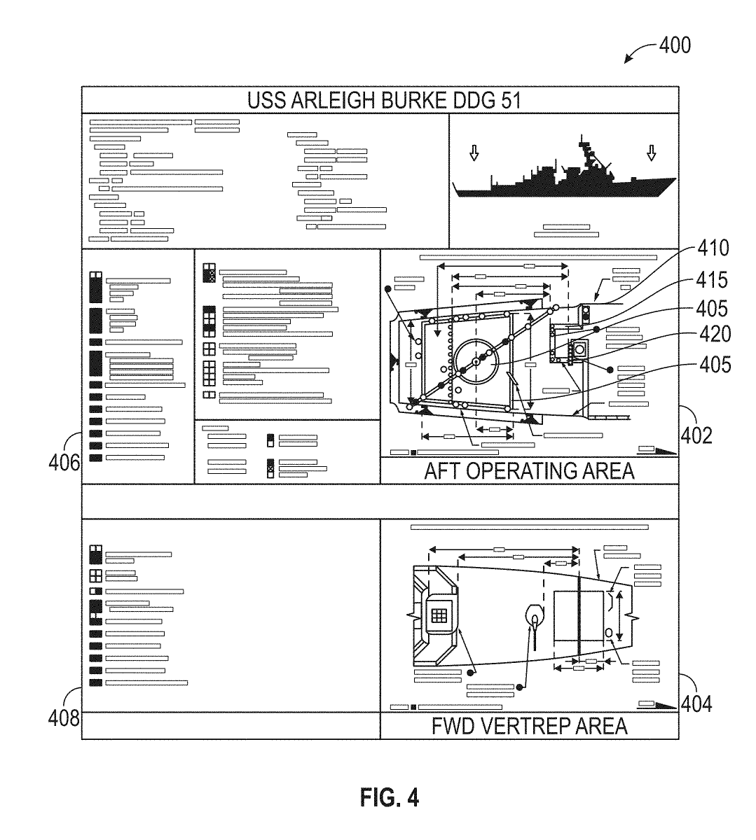

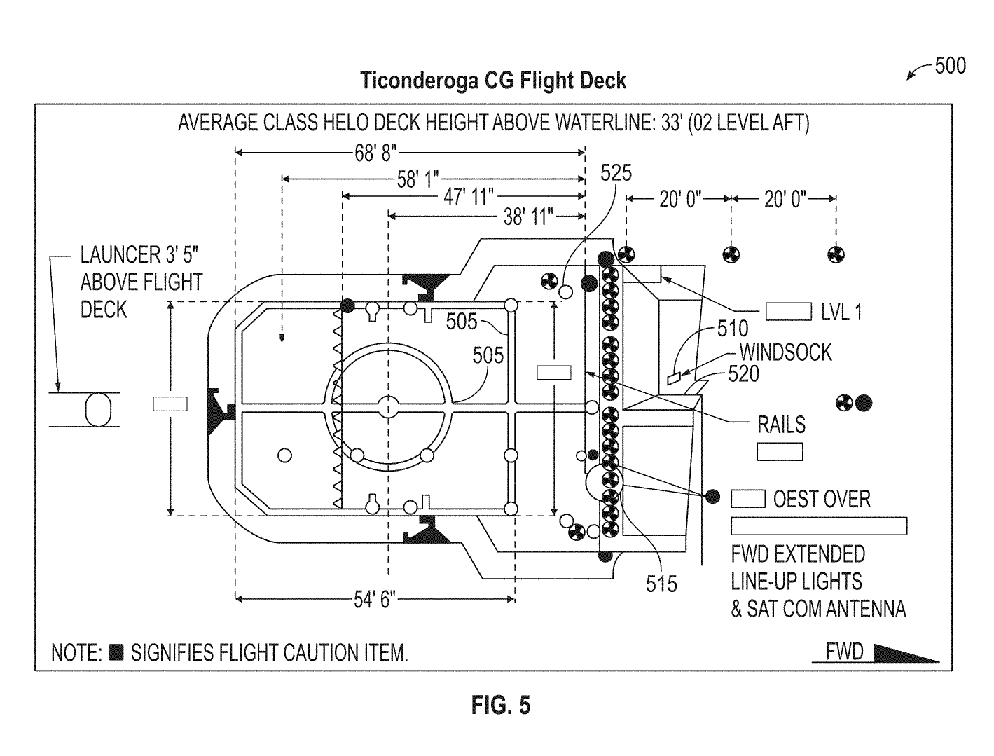

By way of example, the height, width, and length of the real aircraft carrier may also be replicated, as well as the layout and arrangement of the landing pad and other various structures associated with the flight deck. For example, the simulated aircraft carrier structure may include replicated aspects of the stern area, bow area, left side section, right side section, runway section, and the landing pad. More detail regarding the data specifications is explained below with regards to FIGS. 4-5.

By way of example, some of the active aircraft carriers that may be replicated may be the following: Nimitz, Dwight D. Eisenhower, Carl Vinson, Theodore Roosevelt, Abraham Lincoln, George Washington, John C. Stennis, Harry S. Truman, Ronald Reagan, George H. W. Bush, Gerald R. Ford, John F. Kennedy, and Enterprise. However, it should be noted that other aircraft carriers may be replicated and those that are no longer in service may also be replicated for training purposes.

At step 220, a floating platform may be obtained to implement the simulated aircraft carrier structure on top. In some instances, the platform may be a barge, tugboat, or any other platform that is buoyant and capable of supporting the simulated aircraft carrier structure. In some instances, two or more platforms may be tied together in order to provide the necessary length or space to accommodate the simulated aircraft structure on top.

At step 230, the simulated aircraft carrier structure is constructed and implemented on top of the platform in accordance to the obtained data specifications. In some instances, the simulated aircraft carrier structure may be configured so that the installation of the simulated aircraft carrier structure may be easily constructed and deconstructed. This may allow the training simulator to be easily transported and easily installed whenever or wherever needed.

In some embodiments, the simulated aircraft carrier structure may come in the form of a kit, where the kit includes different sections or units of the simulated aircraft structure to be installed onto the platform. By way of example, the units may be divided and labelled as a stern unit, a bow unit, a starboard unit, a port unit, a landing pad unit, a control tower unit, a runway unit, and the like. By connecting all of the individual units together, a complete simulated aircraft carrier structure can be built.

Each of the individual units may have been initially designed and constructed to replicate the those specific sections of the real aircraft carrier of interest. Thus by way of example, in the instance that the kit is to provide a simulated aircraft carrier structure of the John F. Kennedy aircraft carrier, the stern unit, the bow unit, the starboard unit, the port unit, the landing pad unit, the control tower unit, the runway unit, and any other unit pieces may each be designed to mimic the exact specifications of the John F. Kennedy aircraft carrier, or any other real aircraft carrier of interest. In other instances, the kit may be a generalized model of a standard or typical aircraft carrier.

When ready to install the kit onto the platform to create a simulated aircraft carrier, the individual units may be sealed together to secure the units together. Additionally, the individual units may be properly sealed to prevent the water from entering. When all of the appropriate units are attached and sealed, the platform may be lowered onto a body of water.

However, by way of example, the kit may be configured so that not all unit pieces need to be connected and implemented onto the platform. Instead, one may decide to only implement a few select pieces of the unit onto the platform. This may be ideal when the training objective only requires the use of select and key areas of the simulated aircraft carrier. Thus, the option to only install select units may save time and resources in the assembly of the simulated aircraft carrier.

For example, if the training objective is to have the crew practice the hand signaling or the radio commands to illuminate the lights required to help guide the aircraft onto the landing pad, the entire simulated aircraft carrier structure may not be necessary for that particular training objective. In another example, should the training objectives be targeted to prepare both the pilot and crew to pass their deck landing qualifications, the platform may be set up to simulate the entire flight deck of the aircraft carrier of interest. This may then allow for the pilot to practice the skills necessary to land the aircraft onto the runway while also allowing crew members to simultaneously practice the necessary skills required to aid the pilot in landing the aircraft carrier out on the flight deck. Thus, the kit allows for the flexibility in implementing all or select sections of the flight deck or the aircraft carrier itself.

Next, at step 240, once the platform is set up with the necessary sections the simulated aircraft carrier structure and lowered onto a body of water, the pilot and crew in training may then begin their training on the simulated aircraft carrier. By placing the platform out onto a body of water, the trainings may closely mimic the environmental conditions the pilot and crew will face when operating on the real aircraft carriers.

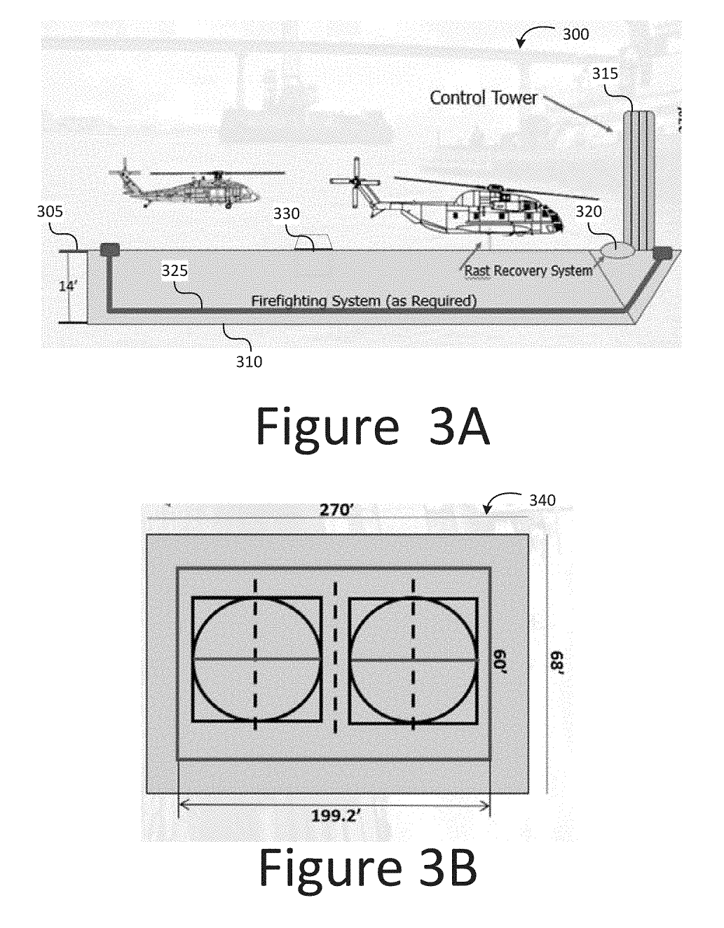

FIG. 3A illustrates a side view of a simulated aircraft carrier structure 300 according to one embodiment. The simulated aircraft carrier structure 300 may have the exact specifications as the real aircraft carrier of interest that is replicated for purposes of the training simulator. By way of example, the height 305 and the length 310 of the of the real aircraft carrier may be replicated onto the simulated aircraft carrier structure 300. Additionally, the simulated aircraft carrier structure 300 may be replicated to have the exact or similar physical structural detail so that to the naked eye, the simulated aircraft structure 300 looks as if it were the sections of the true aircraft structure. As a result, the simulated aircraft carrier structure 300 may replicate the geospatial relationships of the structures and areas to provide a true replica of the aircraft carrier. Such detailed data required to replicate the real aircraft carrier can be gathered from blueprint, models, and replicas of the real aircraft carriers. Such data specifications are depicted and explained in further detail in FIGS. 4 and 5.

Referring to FIG. 3A, the simulated aircraft carrier structure 300 may also include a control tower 315. Again, the replicated control tower structure may be identical in size, height, and width to the real control tower on the true aircraft carrier. In some instances, the control tower 315 may be fully operational so that a the pilot may interact with the control tower via radio communication, just as the pilot would procedurally do when landing or taking-off from the real aircraft carrier.

Indeed, the control tower 315 plays an important role in the landing of the aircraft because it may essentially be the air traffic control center. Thus all decisions in granting the landing and determining the landing order of the waiting planes may be determined by the crew members in the control tower 315. As such, the crew member responsible for providing air traffic guidance in the control tower 315 must undergo proper training related to properly communicating with the pilots and giving them clearance, guidance, and instructions to the pilot. Thus, a control tower 315 may be replicated for the training simulator to provide such crew members training in air traffic guidance.

Accordingly, in some embodiments, the control tower 315 may be fully equipped to be operational with the simulated aircraft carrier and the aircraft carriers used to train the pilots. Additionally, the interior layout of the control tower 315, including the equipment type and equipment layout, may also be replicated from the control tower of the true aircraft carrier. Thus, this may allow the crew members training in the control tower to fully understand the duties and skills needed to operate the control tower 315. Thus the control tower 315 may include the necessary electronic and radio hardware to communicate with pilots in aircrafts and even with other crew members on board different sections the simulated aircraft structure 300. Thus, by way of example, the simulated aircraft structure 300 may include the necessary electronic and hardware equipment to ensure that the radio and electronic equipment are fully functional.

In some embodiments, the simulated aircraft carrier structure 300 may also include a recovery system 320, which is a system that can be configured help bring a complete stop to a 50,000 pound aircraft with less than 350 feet of runway space. By way of example, the recovery system 320 may also include arresting gear to rapidly decelerate the aircraft as it lands by using several steel wire ropes, otherwise known as arresting cables, laid in parallel across the landing area, which is to be caught by the aircraft's tail hook. The arresting cables may be attached on both ends of the runway to hydraulic cylinders that are stored below the carrier deck to absorb the kinetic energy created by the force of the aircraft. With the aircraft's tail hook latched onto the arresting cables, this slows the aircraft until it reaches a complete stop. The tail hook may then be removed from the wire and the recovery system 320 may be prepared for the next arrestment for another aircraft.

Different aircraft carriers may have different number of arresting cables laid across the landing area. As a result, the stimulated aircraft carrier structure 300 may have the identical number of arresting cables as used on the real aircraft carrier that is being replicated in order to simulate the environment of that real aircraft carrier.

Additionally, the recovery system 320 may also include a barricade netting to use as an emergency backup in the chance that the aircraft does not reach a complete stop through the conventional tail hook arresting gear or when the aircraft breaks loose from the wire. The barricade netting may attempt to slow the aircraft and even attempt to prevent it from falling over the aircraft carrier and into the ocean

By implementing the recovery system 320, the pilots are able to properly train approaching a landing deck at exact angle, alignment, and speed required to snag the steel wires with the tail hook. Additionally, the recovery system 320 also may be used to train other crew members, such as the crew members responsible for setting up the recovery system 220 and gear to successfully and safely recover the landing aircraft carrier.

Furthermore, the simulated aircraft carrier 300 may also include a firefighting system 325. Because the possibility of a fire starting on the aircraft carrier may be very real, flight-crew members must diligently prepare in how to handle a wide range of emergency scenarios.

The firefighting system 325 may include a small firetruck, fire extinguishers, nozzles located at designated areas to flood the deck with water, and tanks filled with water, aqueous film-forming form or other advanced fire-extinguishing materials. The firefighting system may include any other firefighting equipment used to extinguish fires.

The simulated aircraft carrier 300 may also include other systems to help train the pilot and crew with any other aspects related to the aircraft carrier. For example, the simulated aircraft carrier may also include a fueling system 330 to help train the pilot and crew members in the operations of refueling an aircraft. The fueling system 330 may include operator control panels, motor pump, fuel filter, and a digital controller that are designed to dispense and supply fuel to aircrafts on the flight deck of the aircraft carrier. However, it should be noted that fueling systems 330 will vary on different aircraft carriers and different equipment may be implemented accordingly.

FIG. 3B illustrates a top view of a landing pad section 340 of the simulated aircraft carrier structure of FIG. 3A. The simulated landing pad 340 may be configured on the simulated aircraft carrier structure to have the exact specifications and dimensions as the one on the real aircraft carrier.

FIGS. 4 and 5 illustrate the flight deck specifications 400, 500 for the USS Arleigh Burke D215DG and Ticonderoga CG, both which are real aircraft carriers that were once in active service in the United States Navy. These flight deck specifications 400, 500 may be used to create the simulated deck landing on top of a platform of the training simulator. Thus in some instances, the simulated aircraft carrier structure may only consist of the deck landing structure itself. In other instances, the simulated aircraft carrier structure many consist of the entire replicated aircraft carrier so that it includes the control tower, radio tower, control rooms, and other structures and elements located on the real aircraft carrier.

The flight deck specifications 400, 500 may also include the exact shape, length, and width requirements, so that the deck landing of interest may be replicated accordingly. Specific to FIG. 4, the flight deck specifications 400 may include a visual layout 402, 404 that may visually depict the visual layout of the flight deck to be replicated. Here, the AFT operating area visual layout 402 may include deck paint markings 405, rails 410, electrical enclosures 415, overhead floodlights 420 and any other items, structures or devices. By implementing various real details to the simulated aircraft carrier, this may give the pilot and crew the opportunity to familiarize himself or herself with the flight deck environment of the true aircraft carrier.

Additionally, the flight deck specifications 400 may also include a vertical replenishment visual layout 404 in the instance that the real aircraft carrier includes a vertical replenishment area. Again, the vertical replenishment visual layout 404 may include a visual layout of the vertical replenishment area to be replicated. with it. Thus, the vertical replenishment area may be replicated in accordance to the information and details provided.

Furthermore, the flight deck specification 400 may also include a list 406, 408 of additional information that may be used to replicated the real aircraft carrier, such as additional information regarding the layout and items or systems included in the aircraft carrier, such as wind measuring system, communication system, safety gear, electrical wiring, and the like.

With respect to FIG. 5, provided is another example of a flight deck specification 500. Again, the flight deck specification may be a visual aid that provides the layout and dimensions needed replicate the flight deck for the training simulator. Here, exemplary visual details may include the layout and placement location of the deck paint markings 505, windsocks 510, configurable lighting 515, control tower, 520, and firefighting equipment 425. Additional detail may be provided in the flight speck specification 500 and may incorporated in the training simulator accordingly.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method of implementing a training simulator comprising:
collecting a data specification of an aircraft carrier to be replicated resulting in a simulated aircraft carrier structure;
obtaining a platform to implement the simulated aircraft carrier structure on top of the platform;
lowering the platform onto a body of water; and
implementing a training program to be performed on the training simulator.

2. The method of claim 1, wherein the data specification comprises details regarding a physical layout of the aircraft carrier to be replicated.

3. The method of claim 1, wherein the platform comprises a barge and a tugboat.

4. The method of claim 1, wherein the simulated aircraft carrier structure comprises one or more sections of the aircraft carrier to be replicated.

5. The method of claim 4, further comprising constructing the simulated aircraft carrier structure by implementing one or more sections of the aircraft carrier to be replicated on the platform.

6. The method of claim 5, wherein the one or more section comprises at least one of a stern, a bow, a starboard side, a port side, a flight deck, a landing pad, and a control tower.

7. The method of claim 5, further comprising connecting the one or more structures together in a sealed arrangement.

8. The method of claim 1, wherein the training program comprises training pilots and crew members skills in the deployment and recovery of an aircraft from the simulated aircraft carrier structure.

9. The method of claim 1, further comprising two or more platforms tied together to support the simulated aircraft carrier structure.

10. The method of claim 1, further comprising implementing a firefighting system comprising a firetruck, fire extinguisher, nozzles, and tanks filled with fire-extinguishing materials to the platform.

11. The method of claim 1, further comprising implementing a fueling system comprising an operator control panels, a motor pump, a fuel filter, and a digital controller to the platform.

12. The kit of claim 1, further comprising implementing a recovery system comprising steel wire ropes to the platform.

13. A kit for a training simulator comprising:
a data specification of an aircraft carrier to be replicated resulting in a simulated aircraft carrier structure
a platform; and
one or more units comprising a simulated aircraft carrier structure implemented on top of the platform, wherein the simulated aircraft carrier structure comprises at least one of a stern, a bow, a starboard side, a port side, a flight deck, a landing pad, and a control tower.

14. The kit of claim 13, wherein the platform comprises a barge and a tugboat.

15. The kit of claim 14, further comprising two or more platforms tied together.

16. The kit of claim 13, wherein the one or more units are constructed to each other in a sealed arrangement.

17. The kit of claim 16, wherein the one or more units are installed on the platform to simulate an environment to train in the deployment and recovery of an aircraft.

18. The kit of claim 13, further comprising a firefighting system comprising a firetruck, fire extinguisher, nozzles, and tanks filled with fire-extinguishing materials to be installed on the platform.

19. The kit of claim 10, further comprising a platform with a fueling system comprising an operator control panels, a motor pump, a fuel filter, and a digital controller to be installed on the platform.

20. The kit of claim 10, further comprising a platform with a recovery system comprising steel wire ropes to be installed on the platform.
